(19) United States
(12) Patent Application Publication
(10) Pub. No.: US 2006/0221283 A1
(43) Pub. Date: Oct. 5, 2006

(54) Liquid crystal display device

(76) Inventors: Kenji Nakao, Kanazawa-shi (JP); Kazuhiro Nishiyama, Kanazawa-shi (JP); Mitsutaka Okita, Matto-shi (JP); Daiichi Suzuki, Ishikawa-gun (JP); Shigesumi Araki, Ishikawa-gun (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/441,009

(22) Filed: May 26, 2006

Related U.S. Application Data
(63) Continuation of application No. PCT/JP04/17177, filed on Nov. 18, 2004.

(30) Foreign Application Priority Data
Nov. 28, 2003 (JP) 2003-400844

(51) Int. Cl. G02F 1/1335

(52) U.S. Cl. 349/117

(57) ABSTRACT

Optical compensation elements include first phase plates and second phase plates, which have retardation in a thickness direction. When a value Δn/Δn_{λ} is set by normalizing a retardation amount Δn·d relating to light of each of wavelengths by a retardation amount Δn_{λ}·d relating to light of a predetermined wavelength λ, a normalized value Δn/Δn_{λ} in the first phase plate is less than a normalized value Δn/Δn_{λ} in a liquid crystal layer, and a normalized value Δn/Δn_{λ} in the second phase plate is greater than the normalized value Δn/Δn_{λ} in the liquid crystal layer, with respect to light of wavelengths other than the predetermined wavelength.

### CROSS REFERENCE TO RELATED APPLICATIONS

This is a Continuation Application of PCT Application No. PCT/JP2004/017177, filed Nov. 18, 2004, which was published under PCT Article 21(2) in Japanese.

This application is based upon and claims the benefit of priority from prior Japanese Patent Application No. 2003-400844, filed Nov. 28, 2003, the entire contents of which are incorporated herein by reference.

### BACKGROUND OF THE INVENTION

1. Field of the Invention

The present invention relates generally to a liquid crystal display device, and more particularly to a liquid crystal display device using an OCB (Optically Compensated Bend) technique, which can realize a wide viewing angle and high responsivity.

2. Description of the Related Art

Liquid crystal display devices have been applied to various fields, taking advantage of their features of light weight, small thickness and low power consumption.

In currently widely marketed twisted nematic (TN) type liquid crystal display devices, liquid crystal molecules with optically positive refractive-index anisotropy are oriented with a nearly 90° twist between a pair of substrates. In the TN liquid crystal display device, the optical rotating power of incident light on the liquid crystal layer is adjusted by controlling the twisted orientation of liquid crystal molecules. The TN liquid crystal display device can be relatively easily manufactured, but the viewing angle is narrow and the responsivity is low. Thus, the TN liquid crystal display device is not suitable, in particular, for motion picture display of TV video, etc.

On the other hand, attention has been paid to an OCB liquid crystal display device as a liquid crystal display device that can enhance the viewing angle and improve the responsivity. In the OCB liquid crystal display device, a liquid crystal layer that is held between a pair of substrates includes liquid crystal molecules that can be oriented with a bend. Compared to the TN liquid crystal display device, the OCB liquid crystal display device has an improved responsivity that is higher by an order of magnitude. In addition, the OCB liquid crystal display device advantageously has a wider viewing angle since the effect of birefringence light, which passes through the liquid crystal layer, is optically self-compensated by the orientation state of liquid crystal molecules.

In the case where an image is displayed by the OCB liquid crystal display device, black may be displayed by blocking light at a time of, e.g. high voltage application and white may be displayed by passing light at a time of low voltage application, with the control of birefringence and in combination with a polarizer plate.

When a black image is displayed, a majority of liquid crystal molecules are oriented in an electric-field direction by the high voltage application (i.e. oriented in a normal direction to the substrates). However, liquid crystal molecules in the vicinity of the substrates are not oriented in the normal direction due to interactions with the orientation films. Consequently, light that travels through the liquid crystal layer is affected by a phase difference in a predetermined direction. Owing to the effect of phase difference, in the case of viewing the screen from a front-face side (i.e. in the normal direction to the substrate), the transmittance cannot sufficiently be reduced when a black image is displayed, and the contract deteriorates.

To cope with this problem, a uniaxial phase plate, for instance, may be incorporated in the OCB liquid crystal display device. Thereby, the phase difference of the liquid crystal layer is compensated when a black image is displayed, and the transmittance can sufficiently be reduced, as is conventionally known. Besides, Jpn. Pat. Appln. KOKAI Publication No. 10-197862, for instance, discloses that phase plates including hybrid-aligned optically negative anisotropy elements are combined, whereby a black image with a sufficiently low transmittance is displayed or gray-level characteristics are compensated when the screen is obliquely viewed.

In the structure of the conventional OCB liquid crystal display device, coloring occurs when the screen is viewed in an oblique direction. Such coloring occurs with respect to any color (any wavelength color). However, in the case where a black image is displayed, bluish coloring is particularly recognized when the screen is viewed in an oblique direction, relative to a direction perpendicular to a rubbing direction (direction of liquid crystal orientation) of an orientation film.

### BRIEF SUMMARY OF THE INVENTION

The present invention has been made in consideration of the above-described problem, and the object of the invention is to provide a liquid crystal display device with excellent display quality, which can increase a viewing angle and improve responsivity.

According to an aspect of the present invention, there is provided a liquid crystal display device characterized by comprising:

a liquid crystal panel that is configured to include a liquid crystal layer held between a pair of substrates; and

an optical compensation element that optically compensates retardation of the liquid crystal layer in a predetermined display state in which a voltage is applied to the liquid crystal layer,

wherein an image is displayed by varying a birefringence amount due to liquid crystal molecules included in the liquid crystal layer by the voltage applied to the liquid crystal layer,

the optical compensation element includes at least a first phase plate and a second phase plate, which have retardation in a thickness direction, and

when a value Δn/Δn_{λ} is set by normalizing a retardation amount Δn·d relating to light of each of wavelengths (Δn=(nx+ny)/2−nz, where nx and ny are in-plane principal refractive indices and nz is a principal refractive index in the thickness direction, and d is a thickness) by a retardation amount Δn_{λ}·d relating to light of a predetermined wavelength λ, a normalized value Δn/Δn_{λ} in the first phase plate is less than a normalized value Δn/Δn_{λ} in the liquid crystal layer, and a normalized value Δn/Δn_{λ} in the second phase plate is greater than the normalized value Δn/Δn_{λ} in the liquid crystal layer, with respect to light of wavelengths other than the predetermined wavelength.

### BRIEF DESCRIPTION OF THE SEVERAL VIEWS OF THE DRAWING

FIG. 1 is a cross-sectional view that schematically shows the structure of an OCB liquid crystal display device according to an embodiment of the present invention;

FIG. 2 schematically shows the structure of optical compensation elements that are applied to the OCB liquid crystal display device;

FIG. 3 shows the relationship between the optical-axis directions of optical members of the optical compensation element shown in FIG. 2 and the direction of orientation of liquid crystal;

FIG. 4 is a view for explaining retardation that occurs in the liquid crystal layer when the screen is observed in an oblique direction;

FIG. 5 is a view for explaining optical compensation of retardation that occurs in the liquid crystal layer, as shown in FIG. 4;

FIG. 6 shows an example of wavelength-dispersion characteristics of a retardation amount Δn·d in each of the optical members in the liquid crystal display device with the structure shown in FIG. 2;

FIG. 7 schematically shows the structure of an OCB liquid crystal display device according to a first embodiment of the invention;

FIG. 8 shows an example of wavelength-dispersion characteristics of a retardation amount Δn·d in each of optical members in the liquid crystal display device with the structure shown in FIG. 7;

FIG. 9 schematically shows the structure of an OCB liquid crystal display device according to a second embodiment of the invention;

FIG. 10 schematically shows the structure of an OCB liquid crystal display device according to a third embodiment of the invention;

FIG. 11 schematically shows the structure of an OCB liquid crystal display device according to a fourth embodiment of the invention; and

FIG. 12 shows an example of wavelength-dispersion characteristics of a retardation amount Δn·d in each of optical members in the liquid crystal display device having the structure shown in FIG. 11.

### DETAILED DESCRIPTION OF THE INVENTION

A liquid crystal display device according to an embodiment of the present invention will now be described with reference to the accompanying drawings. In this embodiment, in particular, an OCB liquid crystal display device that adopts an OCB (Optically Compensated Bend) mode as a display mode is described as an example of the liquid crystal display device.

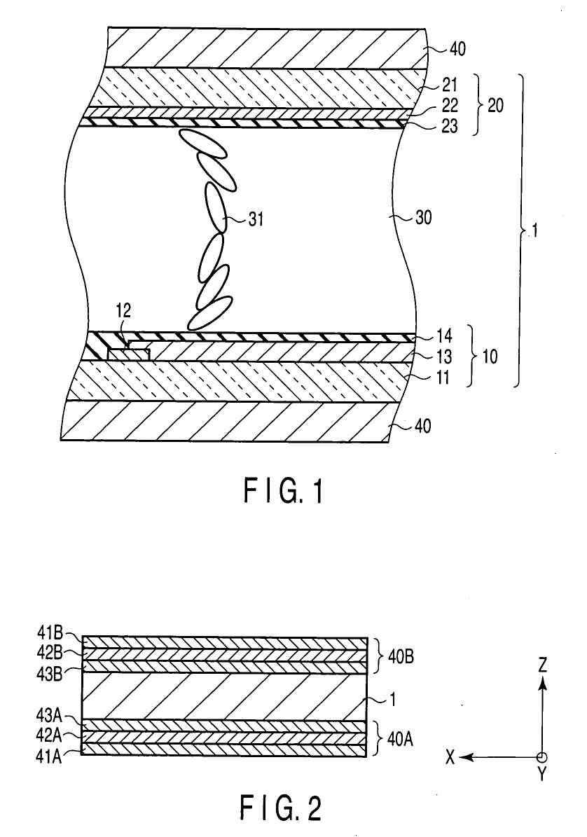

As is shown in FIG. 1, the OCB liquid crystal display device includes a liquid crystal panel 1 that is configured such that a liquid crystal layer 30 is held between a pair of substrates, that is, an array substrate 10 and an opposed substrate 20. The liquid crystal panel 1 is, for example, of a transmissive type and is configured to pass backlight from a backlight unit (not shown) from the array substrate 10 side to the opposed substrate 20 side.

The array substrate 10 is formed using an insulating substrate 11 of, e.g. glass. The array substrate 10 includes an active element 12, a pixel electrode 13 and an orientation film 14 on one major surface of the insulating substrate 11. The active element 12 is disposed for each pixel and is composed of, e.g. a TFT (Thin Film Transistor) or a MIM (Metal Insulated Metal). The pixel electrode 13 is electrically connected to the active element 12 that is disposed for each pixel. The pixel electrode 13 is formed of a light-transmissive, electrically conductive material such as ITO (Indium Tin Oxide). The orientation film 14 is disposed so as to cover the entire major surface of the insulating substrate 11.

The opposed substrate 20 is formed using an insulating substrate 21 of, e.g. glass. The opposed substrate 20 includes a counter-electrode 22 and an orientation film 23 on one major surface of the insulating substrate 21. The counter-electrode 22 is formed of a light-transmissive, electrically conductive material such as ITO. The orientation film 23 is disposed so as to cover the entire major surface of the insulating substrate 21.

In the color-display type liquid crystal display device, the liquid crystal panel 1 includes color pixels of a plurality of colors, e.g. red (R), green (G) and blue (B). Specifically, the red pixel has a red color filter that mainly passes light of a red wavelength. The green pixel has a green color filter that mainly passes light of a green wavelength. The blue pixel has a blue color filter that mainly passes light of a blue wavelength. These color filters are disposed on the major surface of the array substrate 10 or opposed substrate 20.

The array substrate 10 and opposed substrate 20 having the above-described structures are attached to each other with a predetermined gap via spacers (not shown). The liquid crystal layer 30 is formed of a liquid crystal composition that is sealed in the gap between the array substrate 10 and opposed substrate 20. A material, which contains liquid crystal molecules 31 with positive dielectric-constant anisotropy and optically positive uniaxiality, can be chosen for the liquid crystal layer 30.

The OCB liquid crystal display device includes optical compensation elements 40 that optically compensate retardation of the liquid crystal layer 30 in a predetermined display state in which a voltage is applied to the liquid crystal layer 30. As is shown in FIG. 2, for example, the optical compensation elements 40 are provided on the array substrate (10)-side outer surface of the liquid crystal panel 1 and on the opposed substrate (20)-side outer surface of the liquid crystal panel 1.

The optical compensation element 40A on the array substrate 10 side includes a polarizer plate 41A and a plurality of phase plates 42A and 43A. Similarly, the optical compensation element 40B on the opposed substrate 20 side includes a polarizer plate 41B and a plurality of phase plates 42B and 43B. Each of the phase plates 42A and 42B functions as a phase plate having retardation (phase difference) in its thickness direction, as will be described later. In addition, each of the phase plates 43A and 43B functions as a phase plate having retardation (phase difference) in its front-plane direction, as will be described later.

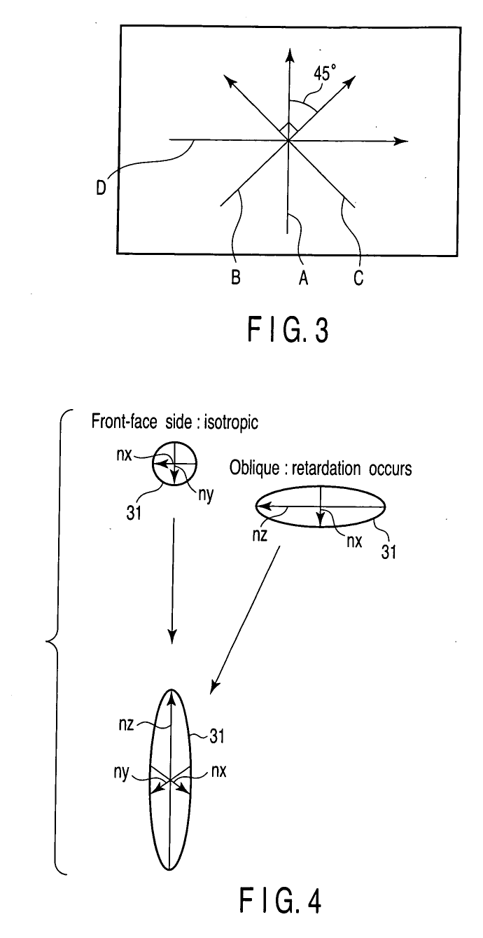

As is shown in FIG. 3, the orientation films 14 and 23 are subjected to a parallel orientation process (i.e. rubbed in a direction of arrow A in FIG. 3). Thereby, an orthogonal projection of the optical axis of the liquid crystal molecules 31 (i.e. direction of liquid crystal orientation) becomes parallel to the direction of arrow A. In a state in which an image can be displayed, that is, in a state in which a predetermined bias is applied, the liquid crystal molecules 31 are oriented with a bend, as shown in FIG. 1, in a cross section of the liquid crystal layer 30, which is defined by the arrow A, between the array substrate 10 and opposed substrate 20.

In this case, the polarizer plate 41A is so disposed as to have a transmission axis in a direction of arrow B in FIG. 3. In addition, the polarizer plate 41B is so disposed as to have a transmission axis in a direction of arrow C in FIG. 3. The transmission axes of the polarizer plates 41A and 41B are inclined at 45° to the direction A of liquid crystal orientation and intersect at right angles with each other. This configuration in which the transmission axes of the two polarizer plates intersect at right angles with each other is called “crossed Nicols”. If a birefringence amount (retardation amount) of an object lying between the two polarizer plates is effectively 0, no light passes (zero transmittance) and a black image is displayed.

In the OCB liquid crystal display device, even if a high voltage is applied to the bend-oriented liquid crystal molecules, all liquid crystal molecules are not oriented in the normal direction of the substrates and the retardation of the liquid crystal layer does not completely become zero. For example, in the liquid crystal panel 1 shown in FIG. 1, when a potential difference of 4.5V was applied between the pixel electrode 13 and counter-electrode 22, the retardation amount of the liquid crystal layer 30 was 60 nm.

The optical compensation elements 40 include phase plates that have such retardation as to cancel the retardation of the liquid crystal layer 30, which has an effect when the screen is viewed from the front-face side in a predetermined voltage application state (e.g. in a state in which a black image is displayed by high voltage application). The optical axis of such phase plates is parallel to a direction D that is perpendicular to the direction in which retardation occurs in the liquid crystal layer 30, that is, the direction A of liquid crystal orientation, and the phase plates have retardation in the direction D. Each of these phase plate corresponds to the “phase plate having retardation in its front-plane direction” 43A, 43B. The front-plane direction, in this context, is an in-plane direction defined by an X direction and a Y direction, that is, defined by the major surface of the liquid crystal panel 1. The refractive indices of the optical members, such as the liquid crystal layer and phase plates, are set in consideration of not only principal refractive indices nx and ny in the plane, but also all the principal refractive indices nx, ny and nz at the time each optical member is orthogonal-projected in the plane.

Thereby, the retardation of the liquid crystal layer 30 in the front-plane direction can be canceled, and the retardation amount can be reduced to effectively zero by the combination of the liquid crystal layer 30 and phase plates 43A and 43B. Thus, when the screen is viewed from the front-face side, a black image can be displayed with a sufficiently decreased transmittance. In other words, the black display state corresponds to the display state in which the retardation amount of the liquid crystal layer 30 is adjusted by the application voltage and balanced with the retardation amount of the phase plates 43A and 43B.

As described above, in the OCB liquid crystal display device, the display quality of the black image, when viewed from the front side, can be improved by the above-described mechanism using the phase plates 43A and 43B that have retardation in the front-plane direction. However, this is not the complete adjustment by phase plates that are included in the optical compensation elements 40. One of the features of the OCB liquid crystal display device is a wide viewing angle. The OCB liquid crystal display device does not necessarily have a wide viewing angle. A wide viewing angle can be obtained by adjusting and balancing the retardations of the liquid crystal layer and the phase plates.

In the liquid crystal display device having the feature of a wide viewing angle, the viewing angle characteristics of a black image are particularly important. The reason is that the quality of blackness of a black image greatly affects the sharpness and contract of a display image. Consideration will now be given to optical compensation by which a wide viewing angle is realized when a black image is displayed, that is, a black image with a sufficiently reduced transmittance can be displayed even if the image is viewed at any angle.

When a black image is displayed on the OCB liquid crystal display device, a relatively high voltage is applied to the liquid crystal layer 30. Thus, a majority of liquid crystal molecules 31 are oriented in the direction of electric field (i.e. erected in the normal direction of the substrate). The liquid crystal molecule 31 is a molecule having such positive uniaxial optical characteristics that a principal refractive index nz in the major-axis direction of the molecule is greater than each of principal refractive indices nx and ny in other directions, as shown in FIG. 4. For the purpose of convenience, the major-axis direction (i.e. thickness direction) of the liquid crystal molecule 31 is referred to as a Z direction, and in-plane directions that are perpendicular to the major-axis direction are referred to as an X direction and a Y direction.

In the state in which the liquid crystal molecule 31 is erected in the normal direction of the substrate, the distribution of principal refractive indices is isotropic (i.e. the in-plane principal refractive indices are equal (nx=ny)) when the screen is viewed from the front-face side, and thus no retardation occurs. However, when the screen is viewed in an oblique direction, the effect of the principal refractive index nz of the liquid crystal molecule 31 is not negligible (nx, ny<nz), and thus retardation occurs in accordance with the direction in which the screen is viewed. Consequently, part of the light traveling through the liquid crystal layer 30 passes through the crossed-Nicol polarizer plates 41A and 41B. In other words, the transmittance cannot sufficiently be reduced, and a black image cannot be displayed.

To cope with this problem, the optical compensation element 40 includes a phase plate having optical characteristics (e.g. negative uniaxiality) that are reverse to the optical characteristics of the liquid crystal molecule 31. This phase plate has a relatively small principal refractive index nz in its thickness direction and relatively large principal refractive indices nx and ny (nx, ny>nz). This phase plate corresponds to the “phase plate having retardation in its thickness direction” 42A, 42B. The thickness direction, in this context, is a direction that is defined, in addition to the in-plane X direction and Y direction, by a Z direction that is perpendicular to the X direction and Y direction. The refractive index of each of the optical members, such as the liquid crystal layer and phase plates, is set in consideration of all principal refractive indices nx, ny and nz in the three-dimensional fashion.

By using the phase plates 42A and 42B combined, the retardation in the liquid crystal layer 30 can be canceled when the screen in the black display state is viewed in an oblique direction.

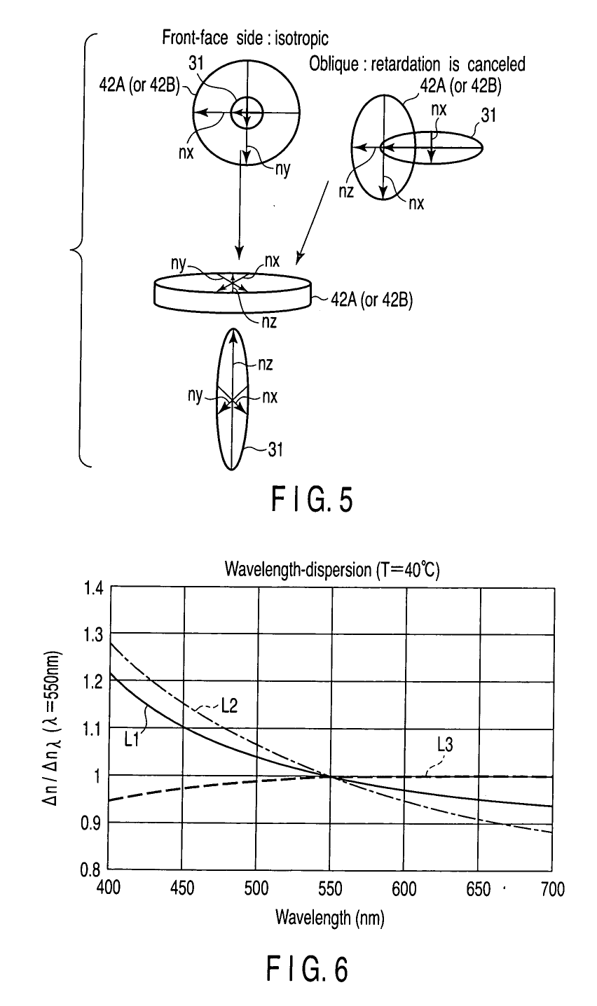

Specifically, as shown in FIG. 5, when the screen is viewed from the front-face side, the distribution of principal refractive indices is isotropic (i.e. the in-plane principal refractive indices are equal (nx=ny)) both in the liquid crystal molecule 31 and the first phase plate 42A (or 42B), and no retardation occurs. On the other hand, when the screen is obliquely viewed, the retardation occurring in the liquid crystal molecule 31 intersects the retardation occurring in the phase plate 42A (or 42B). That is, the distribution of principal refractive indices in the liquid crystal molecule 31 becomes nx, ny<nz, and such retardation occurs in the liquid crystal layer 30 that the effect of the principal refractive index nz in the thickness direction is dominant. On the other hand, the distribution of principal refractive indices in the phase plate 42A (or 42B) becomes nx, ny>nz, and such retardation occurs in the phase plate that the effect of the principal refractive index nx or ny in the plane perpendicular to the thickness direction is dominant.

If the absolute values of the amounts of retardations in the liquid crystal layer and phase plate are made substantially equal, these retardations can be canceled. Thereby, the retardation in the thickness direction of the liquid crystal layer 30 can be canceled, and the state in which the retardation amount is effectively zero can be realized by combining the liquid crystal layer 30 and phase plates 42A and 42B. Thus, even when the screen is obliquely viewed, a black image with a sufficiently reduced transmittance can be displayed. For the purpose of convenience, the retardation amount is defined as Rth=Δn×d, where Δn is ((nx+ny)/2−nz), and d is the thickness of the liquid crystal layer or the phase plate.

As stated above, the basic approach to realize a wide viewing angle in the OCB liquid crystal display device is to cancel the retardation occurring in the liquid crystal layer in the front-plane direction by the “phase plates having retardation in the front-plane direction” and to cancel the retardation occurring in the liquid crystal layer in the oblique direction by the “phase plates having retardation in the thickness direction”.

The phase plate 43A, 43B with retardation in the front-plane direction may be a film in which optical anisotropic elements, e.g. discotic liquid crystal molecules, with optically negative uniaxiality are hybrid-aligned in the thickness direction of the phase plate. In addition, the phase plate 42A, 42B with retardation in the thickness direction may be a biaxial film. In short, the film in which discotic liquid crystal molecules are hybrid-aligned and the biaxial film can be interpreted as films having retardation in both the front-plane direction and the thickness direction.

TAC (triacetyl cellulose) films are usable as the phase plates 42A and 42B with retardation in the thickness direction. In this case, the phase plate 42A, 42B itself can also be used as a base film for the polarizer plate 41A, 41B. This method is effective in decreasing the thickness of the optical compensation element and reducing the cost.

In the above description, the single wavelength has been considered. Conventionally, in order to place importance on luminance, retardation has been adjusted so as to optimize the characteristics at the green wavelength of 550 nm or thereabout. However, in both the liquid crystal layer and the phase plates, the principal refractive indices nx, ny and nz have wavelength dependency.

FIG. 6 shows an example of wavelength-dispersion characteristics of retardation amounts Δn·d of the liquid crystal layer, the phase plate having retardation in the front-plane direction, and the phase plate having retardation in the thickness direction. In FIG. 6, the abscissa indicates the wavelength (nm), and the ordinate indicates a value Δn/Δn_{λ}, which is obtained by normalizing the retardation amount Δn·d relating to light of each wavelength by the retardation amount Δn_{λ}·d relating to light of a predetermined wavelength, i.e. λ=550 nm. That is, FIG. 6 shows the wavelength-dispersion characteristics of the value Δn/Δn_{λ}. In FIG. 6, a solid line L1 corresponds to the liquid crystal layer, a dot-and-dash line L2 corresponds to the phase plate having retardation in the front-plane direction, and a broken line L3 corresponds to the phase plate having retardation in the thickness direction.

As is understood, even if proper optical compensation is performed at a wavelength of 550 nm, proper adjustment cannot be effected at different wavelengths and a problem of coloring arises. In particular, at wavelengths less than 550 nm, the wavelength-dispersion characteristics of the phase plate having retardation in the thickness direction are greatly different from those of the liquid crystal layer. Consequently, when the screen is obliquely viewed, the retardation of the liquid crystal layer cannot fully be canceled. In particular, when the screen is observed in an oblique direction, relative to a direction perpendicular to the direction of liquid crystal orientation, bluish coloring is recognized. In this example, a TAC film is used as the phase plate having retardation in the thickness direction.

In order to compensate the difference in wavelength-dispersion characteristics between the liquid crystal layer and the phase plate having retardation in the thickness direction, the optical compensation element includes at least two phase plates (i.e. first phase plate and second phase plate) having retardation in the thickness direction. Embodiments of the OCB liquid crystal display device having such optical compensation elements will be described.

### First Embodiment

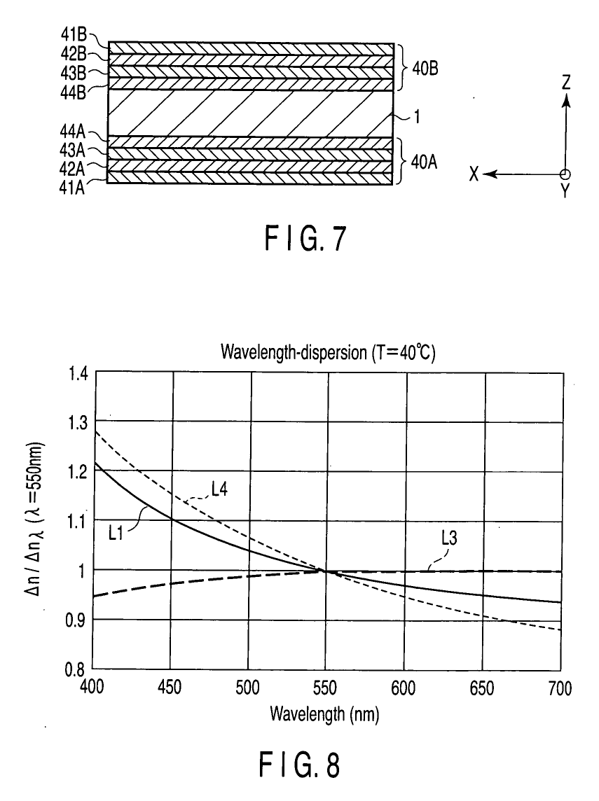

As is shown in FIG. 7, in an OCB liquid crystal display device according to a first embodiment, optical compensation elements 40A and 40B are provided on the array substrate (10)-side outer surface of the liquid crystal panel 1 and on the opposed substrate (20)-side outer surface of the liquid crystal panel 1.

The optical compensation element 40A on the array substrate 10 side includes a polarizer plate 41A, a first phase plate 42A having retardation in its thickness direction, a phase plate 43A having retardation in its front-plane direction, and a second phase plate 44A having retardation in its thickness direction. Similarly, the optical compensation element 40B on the opposed substrate 20 side includes a polarizer plate 41B, a first phase plate 42B having retardation in its thickness direction, a phase plate 43B having retardation in its front-plane direction, and a second phase plate 44B having retardation in its thickness direction. The transmission-axis direction of the polarizer plate and the optical-axis directions of the respective phase plates, relative to the liquid crystal orientation direction, are the same as those in the example shown in FIG. 2 and FIG. 3.

The first phase plates 42A and 42B are, for instance, TAC films, as in the above-described example. The first phase plates 42A and 42B have wavelength-dispersion characteristics as shown by L3 in FIG. 6. Specifically, with respect to light of shorter wavelengths than the predetermined wavelength (550 nm), the normalized value Δn/Δn_{λ} in the first phase plate 42A, 43B is less than the normalized value Δn/Δn_{λ} in the liquid crystal layer 30.

In this case, the second phase plates 44A and 44B, which are to be chosen, should have such wavelength-dispersion characteristics as to compensate the difference in wavelength-dispersion characteristics between the liquid crystal layer 30 and the first phase plates 42A and 42B. In other words, with respect to light of shorter wavelengths than the predetermined wavelength (550 nm), the normalized value Δn/Δn_{λ} in the second phase plate. 44A, 44B needs to be greater than the normalized value Δn/Δn_{λ} in the liquid crystal layer 30. The second phase plates, which meet this condition, have the advantage of canceling the difference in wavelength-dispersion characteristics between the first phase plates and the liquid crystal layer.

For instance, phase plates, in which optical anisotropic elements with negative uniaxiality, such as discotic liquid crystal molecules, are aligned in the thickness direction (normal direction) so that the principal refractive index nz in the thickness direction is relatively small and the principal refractive index nx, ny in the plane is relatively large (nx, ny>nz), can be used for the second phase plates 44A and 44B.

FIG. 8 shows an example of wavelength-dispersion characteristics of retardation amounts Δn·d of the liquid crystal layer, the first phase plate and the second phase plate. Like FIG. 6, FIG. 8 shows the wavelength-dispersion characteristics of the value Δn/Δn_{λ}, which is obtained by normalizing the retardation amount Δn·d relating to light of each wavelength by the retardation amount Δn·d relating to light of the predetermined wavelength, i.e. λ=550 nm. In FIG. 8, a solid line L1 corresponds to the liquid crystal layer, a broken line L3 corresponds to the first phase plate, and a broken line L4 corresponds to the second phase plate.

As is shown in FIG. 8, at wavelengths shorter than the predetermined wavelength, the wavelength-dispersion characteristics of the first phase plate are lower than those of the liquid crystal layer, and the wavelength-dispersion characteristics of the second phase plate are higher than those of the liquid crystal layer. In other words, in a visible wavelength range between 400 nm and 700 nm (or in a range of wavelengths shorter than the predetermined wavelength of 550 nm), a difference between a maximum value and a minimum value of Δn/Δn_{λ} is smaller in the first phase plate than in the liquid crystal layer and is greater in the second phase plate than in the liquid crystal layer. Further, in other words, in the visible wavelength range between 400 nm and 700 nm (or in the range of wavelengths shorter than the predetermined wavelength of 550 nm), the inclination of the wavelength-dispersion characteristic curve is smaller in the first phase plate than in the liquid crystal layer and is greater in the second phase plate than in the liquid crystal layer.

Specifically, the first phase plate, which has lower wavelength-dispersion characteristics of Δn/Δn_{λ} than those of the liquid crystal layer, is combined with the second phase plate, which has higher wavelength-dispersion characteristics of Δn/Δn_{λ} than those of the liquid crystal layer. Thereby, the comprehensive wavelength-dispersion characteristics of the first phase plate and second phase plate are made to be substantially equal to the wavelength-dispersion characteristics of the liquid crystal layer. Thus, when the screen is obliquely viewed, retardation occurring in the liquid crystal layer can be canceled, and the wavelength-dispersion characteristics of retardation in the liquid crystal layer can be compensated.

Hence, when the screen is viewed not only from the front-face side but also in the oblique direction, the transmittance of the liquid crystal panel can sufficiently be reduced and the contrast is enhanced. Moreover, a black image with little coloring can be displayed. Therefore, a liquid crystal display device with excellent viewing-angle characteristics and display quality can be provided.

The above-described optical compensation element 40 can be fabricated, for example, by adding the second phase plate, which has the function of adjusting the comprehensive wavelength-dispersion characteristics of the liquid crystal display device, to the optical element in which the polarizer plate, the first phase plate with retardation in its thickness direction and the phase plate with retardation in its front-plane direction are integrally constructed. For example, the optical compensation element 40 is fabricated by coating a material, which functions as the second phase plate with retardation in the thickness direction, or attaching a film, which functions as the second phase plate, to the surface of this optical element. In short, the optical compensation element includes the second phase plate on its side closest to the liquid crystal panel.

Alternatively, the optical compensation element may be configured such that the first phase plate is provided on the surface of the optical element in which the second phase plate as well as the polarizer plate, etc. are integrally constructed. In this case, the first phase plate is provided on the side closest to the liquid crystal panel.

If the optical compensation element is manufactured by the above-described method, the manufacturing process can be simplified, the manufacturing cost can be reduced, and the cost of the optical compensation element can be reduced. This method is very advantageous in the manufacturing process.

Preferably, the second phase plate (or first phase plate) should have such a thickness as to provide a retardation amount that is substantially equal to the difference between the retardation amount in the first phase plate (or second phase plate) and the retardation amount in the liquid crystal layer with respect to light of the same wavelength. Specifically, the retardation amount, as described above, depends on the thickness d of each optical member. Thus, optimization for canceling the retardation amount of the liquid crystal layer can be executed by adjusting the combination of thicknesses of the phase plates that constitute the optical compensation element and have retardations in the thickness direction.

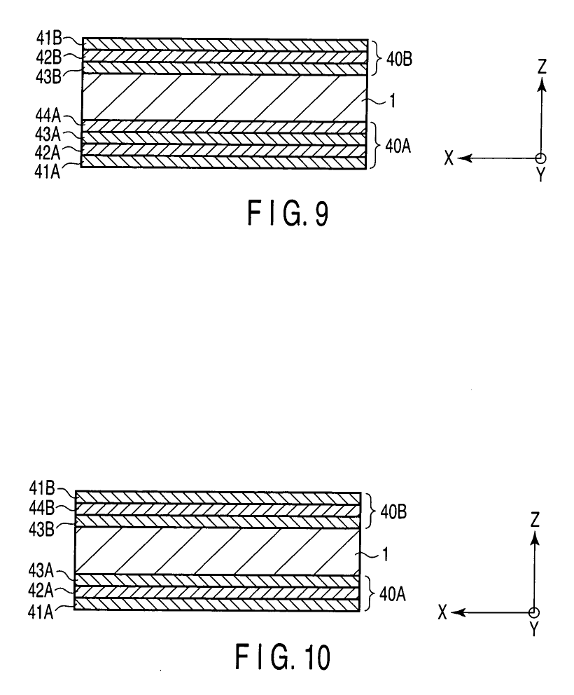

In short, as in the example of FIG. 8, a relatively small thickness is set for the first phase plate that has wavelength-dispersion characteristics of Δn/Δn_{λ} with a relatively small difference from those of the liquid crystal layer. A relatively large thickness is set for the second phase plate that has wavelength-dispersion characteristics of Δn/Δn_{λ} with a relatively large difference from those of the liquid crystal layer. In this example, it is preferable that the thickness of the second phase plate be set at double or more the thickness of the first phase plate. In the first embodiment, an optimal result was obtained when the thickness of the first phase plate 42A, 42B was set at 100 μm and the thickness of the second phase plate 44A, 44B was set at 200 μm, i.e. double the thickness of the first phase plate. (Second Embodiment) As is shown in FIG. 9, like the first embodiment, in an OCB liquid crystal display device according to a second embodiment, optical compensation elements 40A and 40B are provided on the array substrate (10)-side outer surface of the liquid crystal panel 1 and on the opposed substrate (20)-side outer surface of the liquid crystal panel 1. The structural components common to those in the first embodiment are denoted by like reference numerals, and a detailed description thereof is omitted.

The optical compensation element 40A on the array substrate 10 side includes a polarizer plate 41A, a first phase plate 42A, a phase plate 43A having retardation in its front-plane direction, and a second phase plate 44A. On the other hand, the optical compensation element 40B on the opposed substrate 20 side includes a polarizer plate 41B, a first phase plate 42B, and a phase plate 43B having retardation in its front-plane direction. The optical compensation element 40B does not include a phase plate that corresponds to the second phase plate.

As has been described above, the second phase plate (or first phase plate) should preferably have such a thickness as to provide a retardation amount that is substantially equal to the difference between the retardation amount in the first phase plate (or second phase plate) and the retardation amount in the liquid crystal layer with respect to light of the same wavelength.

Thus, optimization for canceling the retardation amount of the liquid crystal layer may be executed by combining the thicknesses of the plural phase plates that constitute the optical compensation element and have retardations in the thickness direction. In other words, no problem arises if the comprehensive wavelength-dispersion characteristics of the two first phase plates 42A and 42B in the liquid crystal display device are canceled with the wavelength-dispersion characteristics of the single second phase plate 44A, and the resultant wavelength-dispersion characteristics of the phase plates are substantially equal to those of the liquid crystal layer 30.

In the second embodiment, when the first phase plate and second phase plate with the wavelength dispersion characteristics as shown in FIG. 8 were applied, an optimal result was obtained by setting the thickness of the first phase plate 42A, 42B at 100 μm and setting the thickness of the second phase plate 44A at 400 μm, i.e. four times the thickness of the first phase plate.

According to the second embodiment, the same advantageous effect as with the first embodiment is obtained. In addition, since the second phase plate is provided on one optical compensation element alone, the number of optical members can be reduced and the cost can be reduced.

### Third Embodiment

As is shown in FIG. 10, like the first embodiment, in an OCB liquid crystal display device according to a third embodiment, optical compensation elements 40A and 40B are provided on the array substrate (10)-side outer surface of the liquid crystal panel 1 and on the opposed substrate (20)-side outer surface of the liquid crystal panel 1. The structural components common to those in the first embodiment are denoted by like reference numerals, and a detailed description thereof is omitted.

The optical compensation element 40A on the array substrate 10 side includes a polarizer plate 41A, a first phase plate 42A, and a phase plate 43A having retardation in its front-plane direction. On the other hand, the optical compensation element 40B on the opposed substrate 20 side includes a polarizer plate 41B, a second phase plate 44B, and a phase plate 43B having retardation in its front-plane direction.

In the third embodiment, when the first phase plate and second phase plate with the wavelength dispersion characteristics as shown in FIG. 8 were applied, an optimal result was obtained by setting the thickness of the first phase plate 42A at 200 μm and setting the thickness of the second phase plate 44B at 400 μm, i.e. double the thickness of the first phase plate.

According to the third embodiment, the same advantageous effect as with the first embodiment is obtained. In addition, since the first phase plate is provided on one optical compensation element alone and the second phase plate is provided on the other optical compensation element alone, the number of optical members can further be reduced and the cost can be reduced.

As has been described in connection with the first to third embodiments, when the liquid crystal display device is constructed, it should suffice if each of the optical compensation elements includes at least one of the optical members functioning as the first phase plate and second phase plate. In other words, the optical member functioning as the first phase plate may be included in at least one of the optical compensation element 40A on the array substrate 10 side and the optical compensation element 40B on the opposed substrate side. Similarly, the optical member functioning as the second phase plate may be included in at least one of the optical compensation element 40A on the array substrate 10 side and the optical compensation element 40B on the opposed substrate side. The combination of the thicknesses of the optical members is optimized to obtain a wide viewing angle and good display quality, as described above.

### Fourth Embodiment

In the above-described embodiments, the problem relating to coloring is solved by combining a plurality of phase plates having retardations in the thickness direction. Alternatively, another method may be adopted. It is possible to adopt a multi-gap structure in which liquid crystal layers of different color pixels have different thicknesses.

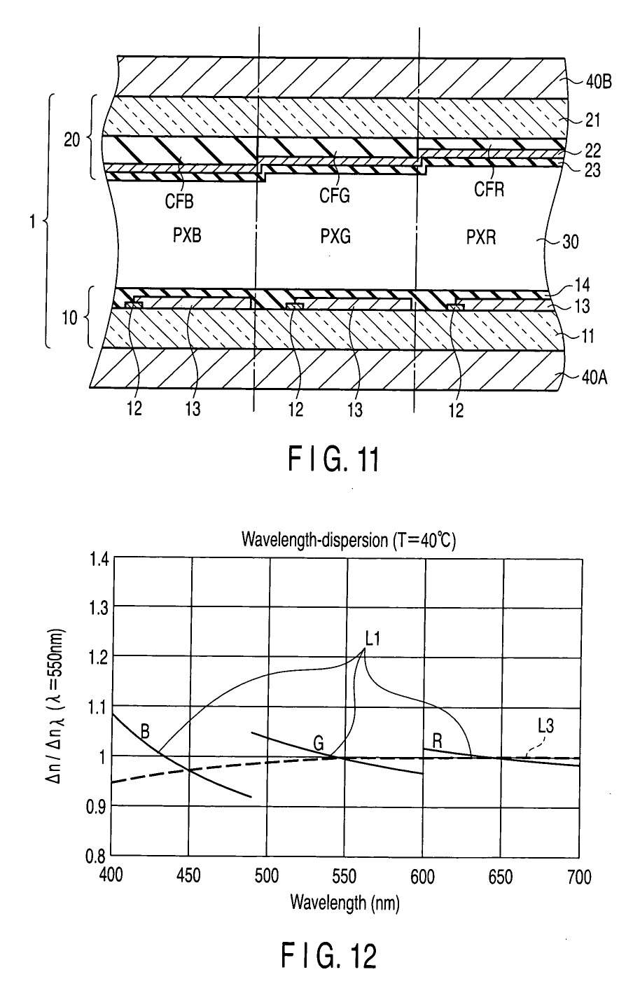

For example, FIG. 11 shows a liquid crystal panel 1 having the multi-gap structure. The liquid crystal panel 1 includes a red pixel PXR, a green pixel PXG and a blue pixel PXB as color pixels of a plurality of colors. The green pixel PXG includes a green color filter CFG with a predetermined thickness on the opposed substrate 20. The red pixel PXR includes a red color filter CFR with a less thickness than the green color filter CFG on the opposed substrate 20. The blue pixel PXG includes a blue color filter CFB with a greater thickness than the green color filter CFG on the opposed substrate 20.

Thereby, when the array substrate 10 and opposed substrate 20 are attached in parallel, a predetermined gap is provided in the green pixel PXG. A gap, which is greater than the gap of the green pixel PXG, is provided in the red pixel PXR. A gap, which is smaller than the gap of the green pixel PXG, is provided in the blue pixel PXB. Thus, such a multi-gap structure is formed that the thickness of the liquid crystal layer 30 of the red pixel PXR is greater than the thickness of the liquid crystal layer 30 of the green pixel PXG, and the thickness of the liquid crystal layer 30 of the blue pixel PXB is smaller than the thickness of the liquid crystal layer 30 of the green pixel PXG.

By controlling the thicknesses of the liquid crystal layers 30 of the respective color pixels, the effective retardation Rth in the liquid crystal layer 30 can be adjusted and the degree of coloring can be reduced.

For example, when the optical compensation elements 40A and 40B as shown in FIG. 2 are combined with the liquid crystal panel 1 with the multi-gap structure, the liquid crystal layer 30 and the phase plates 42A and 42B with retardations in the thickness direction in the respective color pixels have wavelength-dispersion characteristics of retardation amount Δn·d, as shown in, e.g. FIG. 12. Like FIG. 6, FIG. 12 shows the wavelength-dispersion characteristics of the value Δn/Δn_{λ}, which is obtained by normalizing the retardation amount Δn·d relating to light of each wavelength by the retardation amount Δn_{λ}·d relating to light of the predetermined wavelength, i.e. λ=550 nm. In FIG. 12, a solid line L1 corresponds to the liquid crystal layer, and a broken L3 corresponds to the phase plate having retardation in the thickness.

In the liquid crystal panel 1 in this example, the thickness of the liquid crystal layer 30 of the blue pixel PXB is made less than the thickness of the liquid crystal layer 30 of the green pixel PXG by 0.3 μm, and the thickness of the liquid crystal layer 30 of the red pixel PXR is made greater than the thickness of the liquid crystal layer 30 of the green pixel PXG by 0.05 μm.

As is shown in FIG. 12, with the provision of the multi-gap structure, the wavelength-dispersion characteristics of the liquid crystal layer in the respective pixels are sufficiently compensated, in particular, near the central wavelengths (450 nm, 550 nm and 650 nm) of the respective colors.

Thus, if the optical compensation elements in the above-described first to third embodiments are combined with the multi-gap structure liquid crystal panel that has been described here, a still wider viewing angle and higher display quality can be realized. Even in the case where optical compensation cannot completely be effected with the structures of the first to third embodiments and fine adjustment of characteristics needs to be executed, the provision of the above-described multi-gap structure is effective.

In some cases, fine adjustment with the first phase plate and second phase plate is difficult since there are not many choices for optimal materials of the first phase plate and second phase plate. In the case of combining the optical compensation elements of the first embodiment with the multi-gap structure liquid crystal panel, a good display quality of a black image was obtained when the thickness of the liquid crystal layer 30 of the blue pixel PXB was made less than the thickness of the liquid crystal layer 30 of the green pixel PXG by 0.1 μm and the thickness of the liquid crystal layer 30 of the red pixel PXR was made equal to the thickness of the liquid crystal layer 30 of the green pixel PXG. In addition, under these conditions, a good display quality was obtained with no degradation in color purity.

The present invention is not limited to the above-described embodiments. At the stage of practicing the invention, various embodiments may be made by modifying the structural elements without departing from the spirit of the invention. Structural elements disclosed in the embodiments may properly be combined, and various inventions may be made. For example, some structural elements may be omitted from the embodiments. Moreover, structural elements in different embodiments may properly be combined.

For example, each of the first phase plate and second phase plate with retardations in the thickness direction may be a negative uniaxial film such as a PC (polycarbonate) film, or a film in which optical anisotropic elements (e.g. discotic liquid crystal molecules) with negative uniaxiality are aligned in the thickness direction of the phase plate, or a biaxial film that also serves as a film with a phase difference in the transmission-axis direction of the polarizer plate.

The present invention can provide a liquid crystal display device with excellent display quality, which can increase a viewing angle and improve responsivity.

What is claimed is:

1. A liquid crystal display device comprising:
a liquid crystal panel that is configured to include a liquid crystal layer held between a pair of substrates; and
an optical compensation element that optically compensates retardation of the liquid crystal layer in a predetermined display state in which a voltage is applied to the liquid crystal layer,
wherein an image is displayed by varying a birefringence amount due to liquid crystal molecules included in the liquid crystal layer by the voltage applied to the liquid crystal layer,
the optical compensation element includes at least a first phase plate and a second phase plate, which have retardation in a thickness direction, and
when a value Δn/Δn_{λ} is set by normalizing a retardation amount Δn·d relating to light of each of wavelengths (Δn=(nx+ny)/2−nz, where nx and ny are in-plane principal refractive indices and nz is a principal refractive index in the thickness direction, and d is a thickness) by a retardation amount Δn_{λ}·d relating to light of a predetermined wavelength λ, a normalized value Δn/Δn_{λ} in the first phase plate is less than a normalized value Δn/Δn_{λ} in the liquid crystal layer, and a normalized value Δn/Δn_{λ} in the second phase plate is greater than the normalized value Δn/Δn_{λ} in the liquid crystal layer, with respect to light of wavelengths other than the predetermined wavelength.

2. The liquid crystal display device according to claim 1, wherein the liquid crystal molecules are bend-oriented between the pair of substrates in the display state.

3. The liquid crystal display device according to claim 1, wherein the optical compensation element includes the first phase plate or the second phase plate on a side thereof closest to the liquid crystal panel.

4. The liquid crystal display device according to claim 1, wherein the first phase plate is disposed on a side of at least one of the pair of substrates.

5. The liquid crystal display device according to claim 1, wherein the second phase plate is disposed on a side of at least one of the pair of substrates.

6. The liquid crystal display device according to claim 1, wherein the liquid crystal panel includes color pixels of a plurality of colors, and has a multi-gap structure in which the liquid crystal layer has different thicknesses in the color pixels of different colors.

7. The liquid crystal display device according to claim 1, wherein the second phase plate has such a thickness as to provide a retardation amount that is substantially equal to a difference between a retardation amount in the first phase plate and a retardation amount in the liquid crystal layer with respect to light of the same wavelength.

8. The liquid crystal display device according to claim 1, wherein the first phase plate and the second phase plate are negative uniaxial films.

9. The liquid crystal display device according to claim 1, wherein the first phase plate and the second phase plate are films in which optical anisotropic elements with negative uniaxiality are aligned in the thickness direction.

10. The liquid crystal display device according to claim 1, wherein the first phase plate and the second phase plate are biaxial films.
